(19) United States
(12) Patent Application Publication
(10) Pub. No.: US 2012/0266198 A1
(43) Pub. Date: Oct. 18, 2012

(54) Fast Binding of a Cloud Based Streaming Server Structure

(75) Inventors: Chaitanya Kanojia, West Newton, MA (US); Joseph Thaddeus Lipowski, Norwell, MA (US)

(73) Assignee: AEREO, INC., Long Island City, NY (US)

(21) Appl. No.: 13/399,677

(22) Filed: Feb. 17, 2012

Related U.S. Application Data
(60) Provisional application No. 61/444,421, filed on Feb. 18, 2011.

(51) Int. Cl. H04N 21/231; H04N 21/234; H04N 21/2343; H04N 21/61

(52) U.S. Cl. 725/62; 725/92; 725/94

(57) ABSTRACT

A system and method to rapidly switch from a primary content stream to a secondary content stream with minimal delay is provided. In operation, there will often be unused antenna elements. These unused antenna elements will be assigned to capture secondary content that users are most likely to request when changing from their primary content stream to another content stream. Thus, secondary content streams are predicatively captured in preparation of a user requesting a new content stream. The content is stored in a short term buffer is continually aged until a user requests the secondary content. Once requested, the content stream is immediately available to the user requesting the content stream. Also disclosed is a system for prioritized transcoding. Real-time requests for content transmissions are given access to transcode resources whereas requests to record content transmissions are temporary stored for off-peak transcoding.

### RELATED APPLICATIONS

This application claims the benefit under 35 USC 119(e) of U.S. Provisional Application No. 61/444,421, filed on Feb. 18, 2011, which is incorporated herein by reference in its entirety.

### BACKGROUND OF THE INVENTION

Over the air television, which is also referred to as terrestrial television or broadcast television, is a distribution mode for television programming via radio waves through the atmosphere. Some examples of well known major television networks in the United States that broadcast over the air content are ABC, CBS, FOX, NBC, and PBS.

Television networks look for ways to attract new customers and increase viewership. One way that television networks attempt to increase their viewership is by putting their programming online for people to access via the Internet. Typically, the television networks will upload content to their website or some other third party website, such as HULU.COM. The problem for people accessing this online content is that there is limited selection, the most recent episodes are not available, and the content is often outdated.

At the same time, a wide variety of devices are available that can play video content. In addition to the ubiquitous television, many people now watch video on their personal computers and mobile devices, such as smartphones and other mobile computing devices such as tablet or slate computers. Video content is usually accessed through the Internet using subscriber data networks, cellular phone networks, and public and private wireless data networks. Moreover, some televisions now have network connections. And many game consoles have the ability to access video content through proprietary interfaces and also via third-party software such as provided by Netflix, Inc.

### SUMMARY OF THE INVENTION

Recently, a system for enabling network access to an antenna array to capture broadcast content transmissions was described in U.S. patent application Ser. No. 13/299,186, filed on Nov. 17, 2011 by Kanojia and Lipowski, now U.S. Pat. Publ. No. ______, for example, which application is incorporated herein by this reference in its entirety. This system enables users to access antenna feeds over a network connection, including the Internet. Each user is assigned their own unique antenna, in some implementations, to record and/or stream content transmissions, e.g. television programs, from over the air broadcasts. As the users select content transmissions, antenna elements are assigned to capture the broadcast content transmissions, demodulators and decoders process the content transmissions to content transmission data, transcoders transcode the content transmission data to content data, and then the system stores the content data to each of the user's accounts separately for later playback by that user and/or streams the content data to the separate users.

In this processing pipeline, the transcoders are a relatively expensive resource. The process of transcoding MPEG2 to MPEG4 at multiple resolutions, for example, is somewhat computationally intensive and often the transcoding systems must be custom made. Additionally, transcoding of content transmissions is expensive due to the power consumed to perform the transcoding even when optimized custom transcoders are used that provide excellent performance per Watt. It would be desirable to shift transcoding operations to off-peak hours where electricity costs are lower, and possibly ambient temperatures are lower.

The present system and method concern an approach to store the content transmission data in a temporary file store and then transcode the content transmission data later, such as during off-peak hours. Generally, at least some of the content transmissions do not need to be transcoded in real time because they are not being streamed to the users, who instead merely wish to record the content transmissions. Additionally, data storage is fairly inexpensive to purchase, operate, and maintain. Thus, it is more economical and efficient to store the captured content transmissions in a temporary file store when possible and transcode the content at a later time. With this system configuration, the number of transcoders needed to process data is approximated by the average system usage and not the peak system use. The result is that fewer transcoders are required to transcode for the same size user base.

The present system and method also concern an approach to enable users to rapidly switch from a first content stream to a second content stream with minimal latency. In operation, the content transmission capture system will often have unused antennas. These unused antennas are assigned to capture additional broadcast content that the users are most likely to request when changing content streams, e.g., switching TV channels. For example, a user browsing a guide menu and lingering on a particular selection for an extended period is likely to switch to that content stream. Similarly, certain popular television shows are likely to be requested by the users and such requests may be anticipated by the system.

These second content streams are captured and encoded simultaneously with the primary content streams, but are not made available to users until requested by one of the users. The second content streams are stored in temporary buffers that are overwritten after a predetermined amount of time if the content is not selected by a user. These buffers improve the users' experiences in an Internet environment that is non-stationery in connection bandwidth and latency. If a user selects one of the second content streams, then the second content becomes the primary content stream and is immediately available for viewing on the user's device.

In general, according to one aspect, the invention features a method for processing content transmissions. The method includes receiving user requests for content transmissions including requests to receive the content transmissions in real time and requests to record the content transmissions. For the requests to receive the content transmissions in real time, the content transmissions are transcoded to content data and the content data streamed to the users. For the requests to record the content transmissions, at least some of the content transmissions are stored as content transmission data in a temporary file store and then later transcoded to the content data for streaming to the users.

In embodiments, the content transmission data are transcoded into high, medium, and low-rate MPEG-4 video format and advanced audio coding audio format content data, but the content transmission data are stored in the temporary file store in MPEG-2 format.

In other aspects of embodiments, the content transmission data are stored in the temporary file store if transcoder usage exceeds a threshold and the content transmission data in the temporary file store is transcoded to the content data and the content data stored in a file store if the transcoder usage falls below a threshold.

In general, according to another aspect, the invention features a content transmission processing system. The system includes an application server that receives requests for content transmissions from users, wherein the requests include requests to receive the content transmissions in real time and requests to record the content transmissions for later display. The system further includes transcoders for transcoding content transmission data of the content transmissions to content data, a temporary file store for storing content transmission data, and a controller that assigns transcoders to transcode the content transmissions data for the requests to receive the content transmissions in real time and directs at least some of the content transmission data to be stored in the temporary file store for the requests to record the content transmissions for later display. The system further includes a streaming server that streams the content data to users.

In general, according to another aspect, the invention features a method for processing content transmissions. The method includes an encoding system receiving the content transmissions, determining usage of transcoders in the encoding system, and the encoding system storing at least some of the received content transmissions as content transmission data in a temporary file store if the usage of the transcoders exceeds a threshold. The method further includes the encoding system later transcoding the content transmission data stored in the temporary file store to content data.

In general, according to another aspect, the invention features a content transmission processing system. The system includes an application server receiving requests for content transmissions from users and an antenna controller determining usage of transcoders that transcode content transmission data of the content transmissions to content data . At least some of the received content transmissions are stored in a temporary file store as the content transmission data if the usage of the transcoders exceeds a threshold.

In general, according to another aspect, the invention features a method for streaming recorded content transmissions. The method includes receiving user requests for recorded content transmissions and determining if the recorded content transmissions are stored in a temporary file store as content transmission data or in a file store as content data. The method further includes that for the content data stored in the file store, streaming the content data to client devices and for the content transmissions stored in the temporary file store, transcoding the content transmission data to the content data and streaming the content data to client devices. For the content transmissions previously stored in a temporary file store, the transcoded content is also stored in the file store.

In general, according to another aspect, the invention features a system for streaming recorded content transmissions to client devices. The system includes an application server receiving user requests for recorded content transmissions, a stream controller that determines if the user requested content transmissions are stored in a temporary file store as content transmission data or are stored in a file store as content data. An antenna controller instructs transcoders to transcode the user requested content transmissions to the content data if the user requested content transmissions are stored in the temporary file store. The system further includes a streaming server that streams the content data to the client devices.

In general, according to another aspect, the invention features a method for switching to new content data streams. The method includes encoding first content transmissions as first content data, streaming the first content data to client devices for display on user devices, and encoding second content transmissions as second content data and buffering the second content data. The method further includes that upon user selection of the second content data, displaying the second content data on the user devices.

In embodiments, the second content data is streamed to the client devices and possibly buffered in storage mediums of the client devices.

In the alternative, or in addition, the second content data, and usually other content data are buffered in a file store of an encoding system. Upon switch over, this second content data is streamed from the file store to the client devices at an accelerated streaming rate in response to the user selection of the second content data.

Typically, when buffered, the second content data is overwritten after a predefined period of time.

In general, according to another aspect, the invention features a system for streaming content transmissions to client devices. The system includes an encoding system that encodes first content transmissions as first content data and encodes second content transmissions as second content data, a buffer for storing the second content data, and a streaming server that streams the first content data to client devices for display.

In general, according to another aspect, the invention features a method for streaming content data at multiple resolutions. The method includes streaming the content data to client devices at a selected resolution. The method further includes that upon detecting user selection of second content data, streaming the secondary content data to the client devices at a lower resolution and then streaming the content data for the second content transmission data at the selected resolution.

In embodiments, the selected resolution is based on a display resolution of the client devices and/or on available communication channel bandwidth.

In general, according to another aspect, the invention features a system for streaming content data to client devices. The system includes a streaming server that streams the content data to the client devices at a selected resolution and an application server that receives user requests for a second stream of content data. The system further includes that the application server instructs the streaming server to stream the second stream of content data to the client devices at a lower resolution and then later stream the second stream of content data at the selected resolution.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram illustrating a system for the capture and distribution of terrestrial television content transmissions.

FIG. 2 is a flow diagram illustrating the steps for a user to view live stream of content data, set up a future recording, or view previously-recorded content.

FIG. 3A is flow diagram illustrating the steps for the system to schedule a future recording of an over the air broadcast content transmission.

FIG. 3B is a block diagram illustrating how different user requests for content transmissions are processed and encoded by the encoding system.

FIG. 4 is flow diagram illustrating the steps for the system to provide previously recorded content transmissions from the streaming server.

FIG. 5 illustrates the database architecture for storing content data from content transmissions in the broadcast file store.

FIG. 6 is a block diagram illustrating the video processing system for content data within a client device.

FIG. 7 is a flow diagram illustrating the steps for the system to enable users to watch streams of content data on devices in real time while buffering second streams of content data on the capture system.

FIG. 8 is a flow diagram illustrating the steps for encoding and streaming content data to users.

FIG. 9 is a block diagram illustrating the client device receiving and buffering multiple streams of content data.

FIG. 10 is a flow diagram illustrating the steps for the system to enable users to watch streams of content data on devices in real time while buffering secondary streams of content data on the client device.

### DETAILED DESCRIPTION OF THE PREFERRED EMBODIMENTS

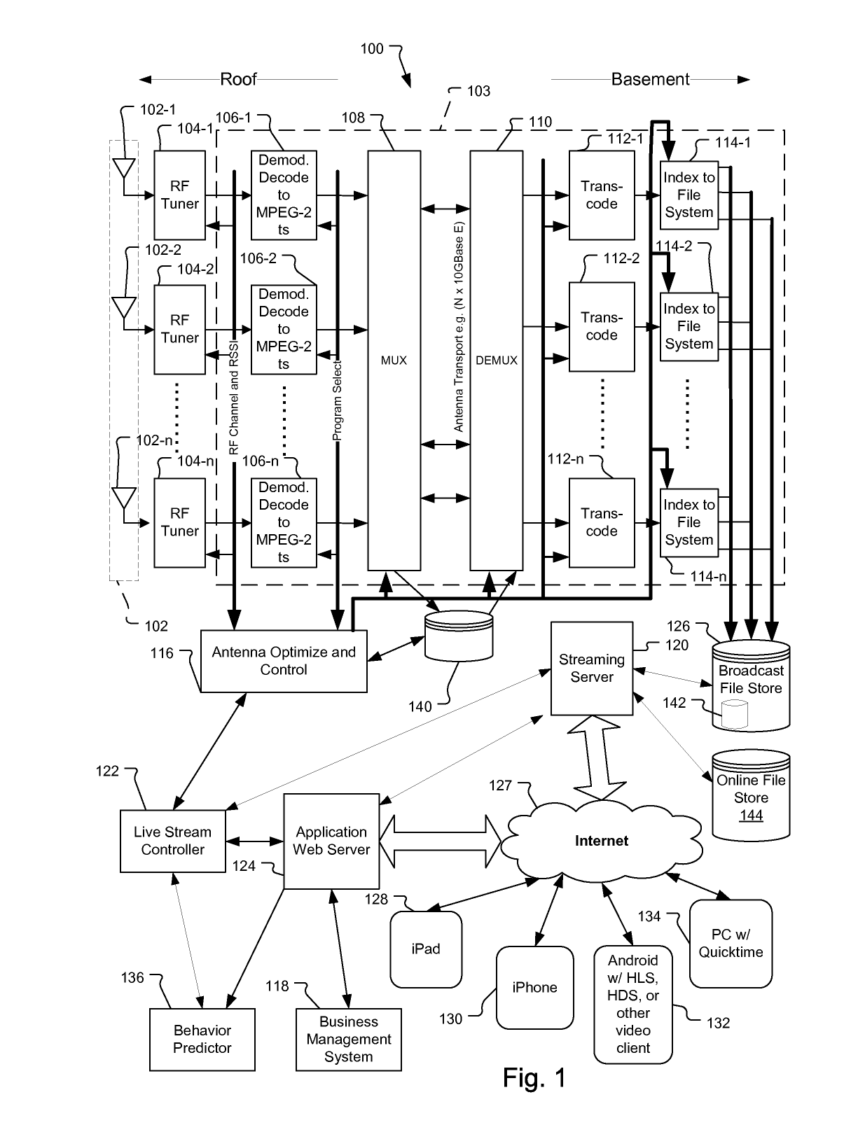

FIG. 1 shows a system 100 that enables individual users to receive terrestrial television content transmissions from antennas via a packet network such as the Internet, which has been constructed according to the principles of the present invention. The system allows each user to separately access the feed from an antenna for recording or live streaming.

In a typical implementation, users access the system 100 via the Internet 127 with client devices 128, 130, 132, 134. In one example, the client device is a personal computer 134 that accesses the system 100 via a browser. In other examples, the system 100 is accessed by mobile devices such as a tablet or slate computing device, e.g., iPad mobile computing device, or a mobile phone, e.g., iPhone mode computing device or mobile computing devices running the Android operating system by Google, Inc. Other examples of client devices are televisions that have network interfaces and browsing capabilities. Additionally, many modern game consoles and some televisions also have the ability to run third-party software and provide web browsing capabilities that can be deployed to access the video from the system 100 over a network connection.

The broadcast content is often displayed using HTML-5 or with a media player executing on the client devices such as QuickTime by Apple Corporation, Windows Media Player by Microsoft Corporation, iTunes by Apple Corporation, or Winamp Media Player by Nullsoft Inc., to list a few examples.

An application web server (or application server) 124 manages requests or commands from the client devices 128, 130, 132, 134. The application server 124 allows the users on the client devices 128, 130, 132, 134 to select whether they want to access previously recorded content, i.e., a television program, set up a future recording of a broadcast of a television program, or watch a live broadcast television program. In some examples, the system 100 also enables users to access and/or record radio (audio-only) broadcasts. A business management system 118 is used to verify the users' accounts or help users set up new accounts if they do not yet have one.

A behavior predictor 136 communicates with the application server 124. The behavior predictor 136 records usage and viewing information about each user and how the users interact with the user interface being served by the application server 124 to their client devices and the content transmissions being streamed to the client devices. The usage, interaction, and viewing information enable the behavior predictor 136 to predict secondary broadcast content that the users are likely to request when requesting new broadcast content. Generally, the behavior predictor 136 is updated whenever the users select broadcast content or switch to secondary broadcast content, and in some examples, whenever the users interact with the user interface served by the application server 124.

In a typical implementation, the behavior predictor 136 builds a profile for each user based on the viewing habits of the user and a generalized profile based on the viewing habits of all the users using the system. A live stream controller 122 sets up streams of secondary content, based on the profile, to be buffered in the broadcast file store 126 or on the client devices 128, 130, 132, 134 depending on the buffering methods used by the system 100.

If the users request to watch previously recorded content transmissions, then the application server 124 sends the users' command to a streaming server 120 and live stream controller 122. The live stream controller 122 locates the requested content. Typically, the previously recorded content transmissions are stored in a temporary MPEG file store 140 as content transmission data or stored in a broadcast file store (or file store) 126 as content data if the content transmission data was previously transcoded.

If the previously recorded content transmissions are in the temporary MPEG file store 140 as content transmission data, then the live stream controller 122 instructs the antenna optimization and control system 116 to allocate transcoders to transcode the content transmission data. On the other hand, if the previously recorded content is stored in the file store 126 as content data, then the live stream controller 122 instructs the streaming server 120 to retrieve each users' individual copy of the previously recorded content transmission from the file store 126 and stream the content data to the client devices 128, 130, 132, 134 from which the request originated.

In some embodiment, streamed content data are provided by an online file store 144. The content data in the online file store 144 are generally additional videos or content transmissions such as on-demand movies, licensed content such as television programs, or user files that were uploaded to the online file store 144, to list a few examples.

If the users request to set up future recordings or watch a live broadcast of content transmissions such as television programs, the application server 124 communicates with the live stream controller 122, which instructs the antenna optimization and control system 116 to configure broadcast capture resources to capture and record the desired broadcast content transmissions by reserving antenna and encoding resources for the time and date of the future recording.

On the other hand, if the users request to watch live broadcast content transmissions, then the application server 124 passes the requests to the live stream controller 122, which then instructs the antenna optimization and control system 116 locate available antenna resources ready for immediate use.

In current embodiments, streaming content is temporarily stored or buffered in the streaming server 120 and/or the broadcast file store 126 prior to playback and streaming to the users whether for live streaming or future recording. This buffering allows users to pause and replay parts of the television program and also have the program stored to be watched again.

In one implementation, the antenna optimization and control system 116 maintains the assignment of this antenna to the user throughout any scheduled television program or continuous usage until such time as the user releases the antenna by closing the session or by the expiration of a predetermined time period as maintained by a timer implemented in the antenna optimization and control system 116. An alternative implementation would have each antenna assigned to a particular user for the user's sole usage. In an alternative implementation, users are assigned new antennas whenever the users request a different live broadcast. In this implementation, the behavior predictor 136 instructs the live stream controller 122 and the antenna optimize and control system 116 to reserve additional antennas to capture the secondary broadcast content for the users.

The broadcast capture portion of the system 100 includes an array 102 of antenna elements 102-1, 102-2 . . . 102-n. Each of these elements 102-1, 102-2 . . . 102-n is a separate antenna that is capable of capturing different terrestrial television content broadcasts and, through a digitization and encoding pipeline, separately process those broadcasts for storage and/or live streaming to the user devices. This configuration allows the simultaneous recording of over the air broadcasts from different broadcasting entities for each of the users. In the illustrated example, only one array of antenna elements is shown. In a typical implementation, however, multiple arrays are used, and in some examples, the arrays are organized into groups.

In more detail, the antenna optimization and control system 116 determines which antenna elements 102-1 to 102-n within the antenna array 102 are available and optimized to receive the particular over the air broadcast content transmissions requested by the users. In some examples, this is accomplished by comparing RSSI (received signal strength indicator) values of different antenna elements. RSSI is a measurement of the power of a received or incoming radio frequency signal. Thus, the higher the RSSI value, the stronger the received signal. In an alternative embodiment, the antenna optimization and control system 116 determines the best available antenna using Modulation Error Ratio (MER). Modulation Error Ratio is used to measure the performance of digital transmitters (or receivers) that are using digital modulation.

After locating an antenna element, the antenna optimization and control system 116 allocates the antenna element to the user. The antenna optimization and control system 116 then signals the corresponding RF tuner 104-1 to 104-n to tune the allocated antenna element to receive the broadcast.

The received broadcasts from each of the antenna elements 102-1 to 102-n and their associated tuners 104-1 to 104-n are transmitted to an encoding system 103 as content transmissions. The encoding system 103 is comprised of encoding components that create parallel processing pipelines for each allocated antenna 102-1 to 102-n and tuner 104-1 to 104-n pair.

The encoding system 103 demodulates and decodes the separate content transmissions from the antennas 102 and tuners 104 into MPEG-2 format using an array of ATSC (Advanced Television Systems Committee) decoders 106-1 to 106-n assigned to each of the processing pipelines. In a situation where each broadcast carrier signal contains multiple content transmissions, the antenna optimization and control system 116 signals the ATSC decoders (or demodulators) 106-1 to 106-n to select the desired program contained on the carrier signal. The content transmissions are decoded to MPEG-2 content transmission data because it is currently a standard format for the coding of moving pictures and associated audio information.

The content transmission data from the ATSC decoders 106-1 to 106-n are sent to a multiplexer 108. The content transmissions are then transmitted across an antenna transport interconnect to a demultiplexer switch 110. In a preferred embodiment, the antenna transport interconnect is an nx10 GbE optical data transport layer.

In the current implementation, the antenna array 102, tuners 104-1 to 104-n, demodulators 106-1 to 106-n, and multiplexer 108 are located outside in an enclosure such as on the roof of a building or on an antenna tower. These components can be made to be relatively robust against temperature cycling that would be associated with such an installation.

The multiplexer 108, demultiplexer switch 110, and nx10 GbE data transport are used transmit the captured content transmission data to the remainder of the system that is preferably located in a secure location such as a ground-level but or the basement of the building, which also usually has a better controlled ambient environment.

The content transmission data of each of the antenna processing pipelines are then transcoded into a format that is more efficient for storage and streaming. In the current implementation, the transcode to the MPEG-4 (also known as H.264) format is effected by an array of transcoders 112-1 to 112-n. Typically, multiple transcoding threads run on a single signal processing core, SOC (system on a chip), FPGA or ASIC type device.

In a typical implementation, at least some content transmission data are transcoded offline and during off-peak hours when the demands on the system resources are lowest and when the content transmission data are not required for real-time viewing by the users. The antenna optimization and control system 116 directs the content transmission data from the multiplexor 108 to the temporary MPEG file store 140 if transcoder usage exceeds a threshold, in one implementation. Generally, the threshold is based on the availability and usage of the transcoders 112-1 to 112-n. The antenna optimization and control system 116 later instructs the transcoders 112-1 to 112-n to transcode the content transmission data stored in the temporary MPEG file store 140. This system configuration enables a smaller number of transcoders to handle user requests because many users do not watch live streaming content.

In alternative embodiments, the antenna optimization and control system 116 directs the majority of the content transmission data to the temporary MPEG file store 140 to further reduce the workload of the transcoders and enable the antenna optimization and control system 116 to more efficiently schedule transcoding resources. Again, this can only happen for the content transmissions that are not required in real-time by the users.

The content transmission data are transcoded to MPEG-4 format to reduce the bitrates and the sizes of the data footprints. As a consequence, the conversion of the content transmission data to MPEG-4 encoding will reduce the picture quality or resolution of the content, but this reduction is generally not enough to be noticeable for the average user on a typical reduced resolution video display device. The reduced size of the content transmissions will make the content transmissions easier to store, transfer, and stream to the user devices. Similarly, audio is transcoded to AAC in the current embodiment, which is known to be highly efficient.

In one embodiment, the transcoded content transmission data are sent to a packetizers and indexers 114-1, 114-2 . . . 114-n of the pipelines, which packetize the data. In the current embodiment, the packet protocol is UDP (user datagram protocol), which is a stateless, streaming protocol. UDP is a simple transmission model that provides less reliable service because datagrams may arrive out of order, duplicated, and go missing. Generally, this protocol is preferred for time-sensitive transmission, such as streaming files, where missing or duplicated packets can be dropped and there is no need to wait for delayed packets.

Also, in this process, time index information is added to the content transmissions. The content data are then transferred to the broadcast file store 126 for storage to the file system, which is used to store and/or buffer the content transmissions as content data for the various content transmission, e.g., television programs, being captured by the users.

In typical embodiments, the content data are streamed to the users with HTTP Live Streaming or HTTP Dynamic Streaming. These are streaming protocols that are dependent upon the client device. HTTP Live Streaming is a HTTP-based media streaming communications protocol implemented by Apple Inc. as part of its QuickTime X and iPhone software systems. The stream is divided into a sequence of HTTP-based file downloads. HDS over TCP/IP is another option. This is an adaptive streaming a communications protocol by Adobe System Inc. HDS dynamically switches between streams of different quality based on the network bandwidth and the computing device's resources. Generally, the content data are streamed using Hypertext Transfer Protocol (HTTP) or Hypertext Transfer Protocol Secure (or HTTPS). HTTPS combines HTTP with the security of Transport Layer Security/Secure Sockets Layer (or TLS/SSL). TLS/SSL are security protocols that provide encryption of data transferred over the Internet.

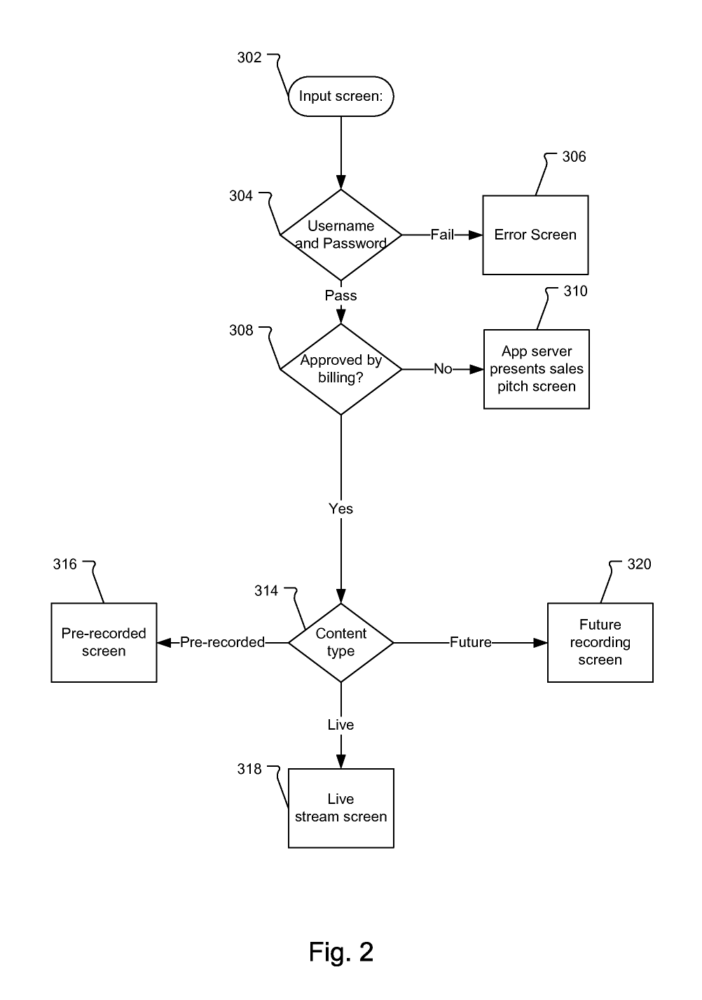

FIG. 2 is a flow diagram illustrating the steps for a user to view a live stream of content data, set up a future recording of a content transmission, or view a previously-recorded content transmission.

In the first step 302, an input screen is presented to the users via their client devices 128, 130, 132, 134. In the next step 304, the users are required to supply their usernames and passwords to access individual user accounts, if not already logged-on. If the user names and passwords are incorrect, then the users are presented with an error screen in step 306.

Once logged-on, the business management system 118 determines if the users are approved for billing in step 308, in the case of a subscription-based service model. If the users are not approved for the billing, then the application server 124 presents the users with a sales pitch screen in step 310, when the system is deployed with a paid-subscriber model.

In the illustrated example, a subscription-based service model is implemented. In addition to being authenticated by username and password, the users must also must provide valid billing information to access and use the system. In alternative embodiments, a free or advertiser sponsored service model may be implemented. In these alternative embodiments, steps 308 and 310 would not be necessary.

In the next step 314, the users are able to select what content type they want to access from their individual user account. Each user is provided with their own individual account through which they access any live content streaming or set up future recordings to be associated with the user's account. Likewise, playback of previously recorded content is done from the user's account and only content associated with the user's account is accessible by the user.

If the user selects content that the user previously recorded, then the user is presented with the pre-recorded screen in step 316. If the user selects future recording, then the user is presented with the future recording screen to set up a future recording in step 320. If the user selects live streaming content, then the user is presented with the live stream screen in step 318. In an alternative embodiment, the live stream screen and future recording screen are displayed with a single interface. The user interface presents a program guide of the live content currently available and/or available in the near future. The users are then able to select content from the program guide to schedule a future recording or begin to watch live streaming content.

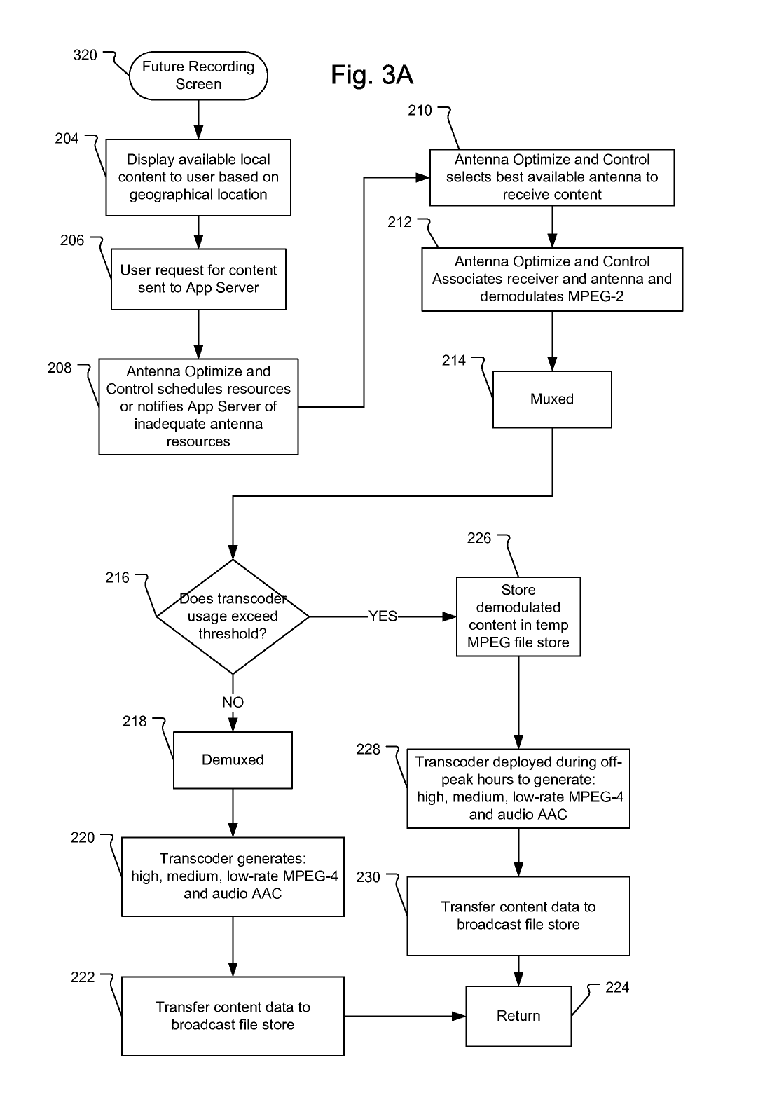

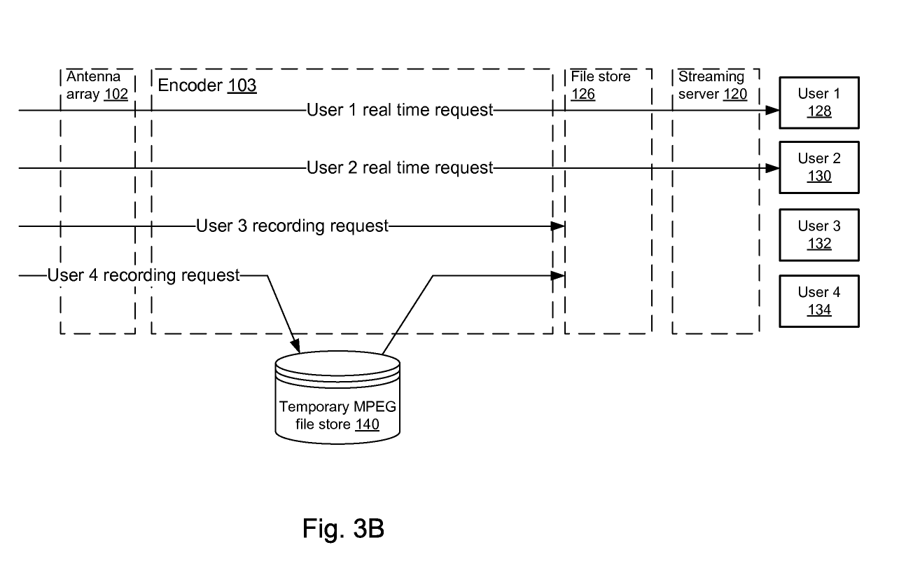

FIG. 3A is flow diagram illustrating the steps for the system to schedule a future recording of an over the air broadcast content transmission. Typically, the system captures and stores separate content transmissions for each user individually so that each user has their own unique copy in the file store 126 that was generated from a separate antenna element, in the current system.

The users begin at the future recording screen that is served to the user device from the application web server 124 in step 320. In the first step 204, the application server 124 determines and displays available local content to the user based on the geographical location information to enable localization. Typically, the user is presented with a list of available television networks, current broadcasts of content transmission or television programs, and times and dates of future broadcasts of content transmissions.

In the next step 206, the user's request for content is sent to the application server 124. The request to the application server 124 are then passed to the live stream controller 122 that then schedules resources to be available at the time of the content broadcast or notifies the user that resources are unavailable in step 208.

The live stream controller 122 directs the antenna optimization and control system 116 to set up the stream, which it does by allocating the best available antenna element at the time and date of the desired broadcast content transmission in step 210. In the case where a user's antenna is assigned permanently this step is skipped, however. In the next step 212, the antenna optimization and control system 116 associates the antenna 102 and demodulator-decoder 106 to demodulate the broadcast content into MPEG-2 format. In the next step 214, the content transmission data are multiplexed by the multiplexer 108.

In the next step 216, the antenna optimization and control system 116 determines if the transcoder usage exceeds the threshold. If the transcoder usage exceeds the threshold, then the antenna optimization and control system 116 instructs the multiplexor 108 to transfer the content transmission data to the temporary MPEG file store 140 in step 226.

In another embodiment, the antenna optimization and control system 116 instructs the multiplexor 108 to transfer the content transmission data to the temporary MPEG file store 140 if electricity is currently expensive. In still another embodiment, content transmission data are sent to the temporary file store for any content transmission that is being captured for recording, i.e., not for live streaming.

In the next step 228, the antenna optimization and control system 116 deploys the transcoders 112-1 to 112-n during off peak hours for usage of the system 100 or for off-peak hours in terms of electrical utility rates to generate the high, medium, and low rate MPEG-4 and audio AAC content data from the content transmission data stored in the temporary file store 140. In the next step 230, the content data are transferred to the file store 126.

If the transcoder usage does not exceed the threshold as determined in step 216, then the demodulated content transmission data are demultiplexed by the demultiplexer switch 110 in step 218. The antenna optimization and control system 116 then instructs the transcoders 112-1 to 112-n generate the high, medium, and low rate MPEG-4 and audio AAC in step 220. In the next 222, the content data are transferred to the broadcast file store 126.

In alternative embodiments, the transcoders could have greater or fewer output rates. The different output rates/resolutions enable the system 100 to provide different quality video streams based on factors such as the network capabilities, the type of client device, the display size of the media player executing on the client devices, and user selections, to list a few examples.

FIG. 3B is a block diagram illustrating how different user requests are processed and encoded by the encoding system 103.

In the illustrated example, users 1 and 2 both requested live streaming of over the air broadcasts. Therefore, the capturing, encoding and streaming of the requested content are performed in real time. The requested broadcast content is captured by the antenna array 102. Then the encoder system 103 encodes the captured content transmission to content transmission data in real time. Next, the content transmission data are buffered and stored in the file store 126. The streaming server 120 then streams the content data from the file store 126 to the client devices 128, 130.

User 3 scheduled a future recording of an over the air broadcast with a client device 132. At the time of the broadcast, the antenna array 102 captures the over the air broadcast. The encoder system 103 then encodes the captured content transmission to content transmission data in real time. Next, the content transmission data are transferred to the file store 126.

User 4 also scheduled a future recording of an over the air broadcast with a client device 134. At the time of the broadcast, the antenna array 102 captures the over the air broadcast. In this scenario, however, the encoder system 103 transfers the content transmission data to the temporary MPEG file store 140 to be transcoded later, for example, during off-peak hours. The content transmission data are then later transcoded and transferred to the file store 126.

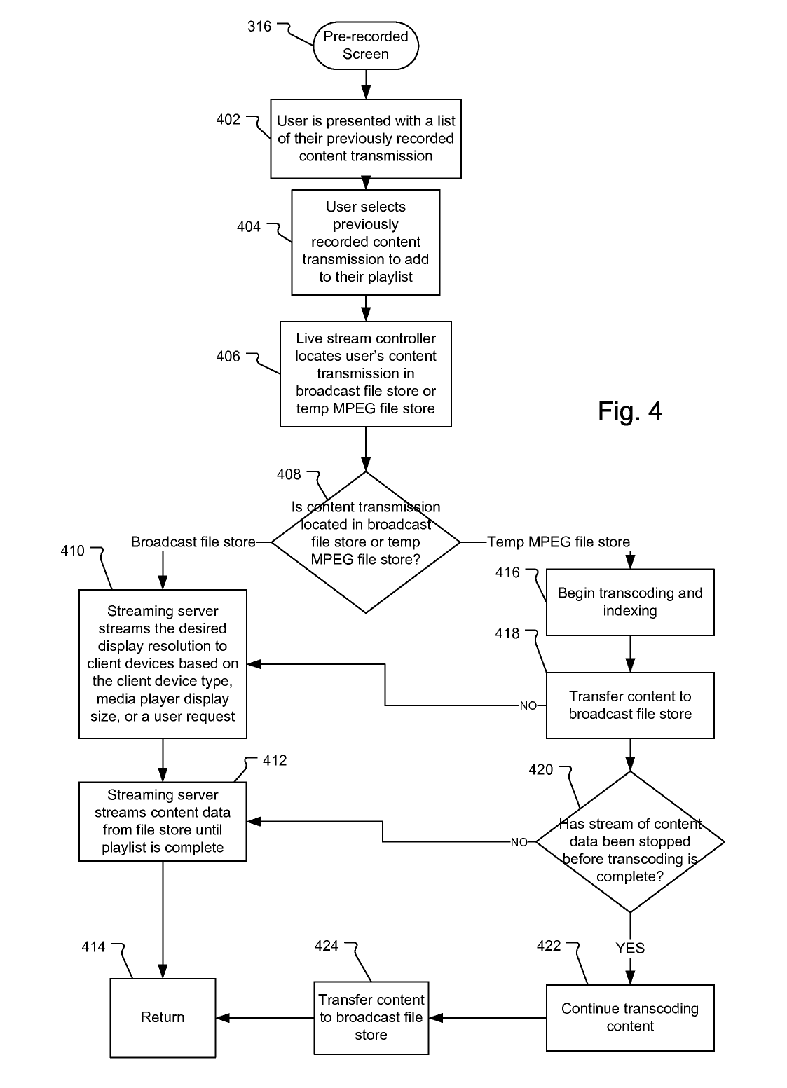

FIG. 4 is flow diagram illustrating the steps for the system to provide previously recorded content transmissions from the streaming server 120.

The users begin at the pre-recording screen that is served to the client devices from the application web server 124 in step 316. This is often a web page. In other examples, a propriety interface is used between the application web server 124 and an application program running on the client devices.

In the first step 402, the user is presented with a list of their previously recorded content transmissions. Typically, users are only able to see the content transmissions, e.g., television programs, that they instructed the system 100 to capture and encode. In some examples, the application server 124 suggests other content transmissions that the users might be interested in watching or recording.

In the next step 404, the user selects one or more of their previously recorded content transmissions to add to a playlist of the media player. In the next step 406, the live stream controller 122 locates the user's content transmissions in the broadcast file store 126 or the temporary MPEG file store 140. The live stream controller 122 then determines whether the selected content transmissions are located in the broadcast file store 126 as content data or the temp MPEG file store 140 as content transmission data in step 408.

If the previously recorded content transmission is stored in the broadcast file store 126 as content data, then the streaming server 120 streams the desired display resolution based on the client device type and as requested by the media player or a user specified request in step 410.

Generally, media players enable users to adjust the size the display window of the media player running on the client devices. The size of the display window of the media player is communicated to streaming server 120. Based on the display size of the media player and the physical screen size of the device, the streaming server 120 streams different resolutions to the client device, in one implementation.

In an alternative embodiment, the client device selects the highest resolution that a communications channel can reliably provide. The communication channels are generally fourth generation cellular wireless networks (or 4G networks), third generation cellular wireless networks (or 3G networks), or wireless/wired local area networks. Typically, 4G networks typically have faster transfer speeds than 3G networks. Similarly, wired local area networks typically have faster transfer speeds than wireless local area networks. Thus, users on 4G networks or wired local area networks would typically receive higher quality video because these networks typically provide faster transfer speeds.

In the next step 412, the streaming server 120 streams the content data from the file store 126 to the client device until the user's playlist is complete.

If the previously recorded content transmissions are stored in the temporary MPEG file store 140 as content transmission data, then the live stream controller 122 instructs the antenna optimization and control system 116 to allocate transcoders and indexers to begin transcoding and indexing the content transmission data in step 416. In the next step 418, the transcoded content transmission data are streamed to the broadcast file store 126 as content data and associated with the user's individual account.

Next, in steps 410 and 412, the streaming server 120 determines the display resolution and streams the content data to the client device. In a typical implementation, the streaming server 120 begins streaming the content data to the client device while the transcoders 112-1 to 112-n are still transcoding the content transmission data.

While the content transmission data in the temporary MPEG file store 140 are being transcoded (step 416), transferred to the file store 126 (step 418), and streamed to the client devices (steps 410 and 412), the streaming server 120 also monitors the stream of content data being streamed to the client device to determine if the stream of content data is stopped before transcoding is complete in step 420.

If the stream of content data is stopped before the transcoding has completed, then the streaming server instructs the antenna optimization and control system 116 to instruct the transcoders to complete the transcoding of the content transmission data in step 422. In the next step 424, the transcoded content transmission data are transferred to the file store 126. This ensures that the content transmission data in the temp MPEG file store 140 are not left partially transcoded.

If the user has not stopped the stream of content data, then the streaming server 120 continues to stream the content data to the client device until the user's playlist is complete in step 412.

Additionally, the live stream controller 122 enables users to view the selected content transmission data at any point in the stream. For example, after users select previously recorded content transmissions for viewing, the users often desire to skip to a certain point in the content transmission. Because at least some of the selected content transmissions are content transmission data in the temporary MPEG file store, some content transmission data will need to be transcoded prior to streaming to client devices. In response to user inputs, the live stream controller 122 instructs the antenna optimize and controller system 116 to configure the transcoders 112-1 to 112-n to begin transcoding at the desired point in the content transmission data. Likewise, as the user skips forward or backward, the live stream controller 122 instructs the antenna optimize and controller system 116 to configure the transcoders 112-1 to 112-n to skip to the corresponding point of the content transmission data.

Additionally, if the stream of content data is stopped before the transcoding has completed or user started watching from some point in the middle of the stream of content data, then the streaming server 120 instructs the antenna optimization and control system 116 to instruct the transcoders to complete the transcoding of the content transmission data. The transcoded content transmission data are then transferred to the broadcast file store 126. As before, this ensures that the content transmission data are not left partially transcoded because the user did not start viewing at the beginning

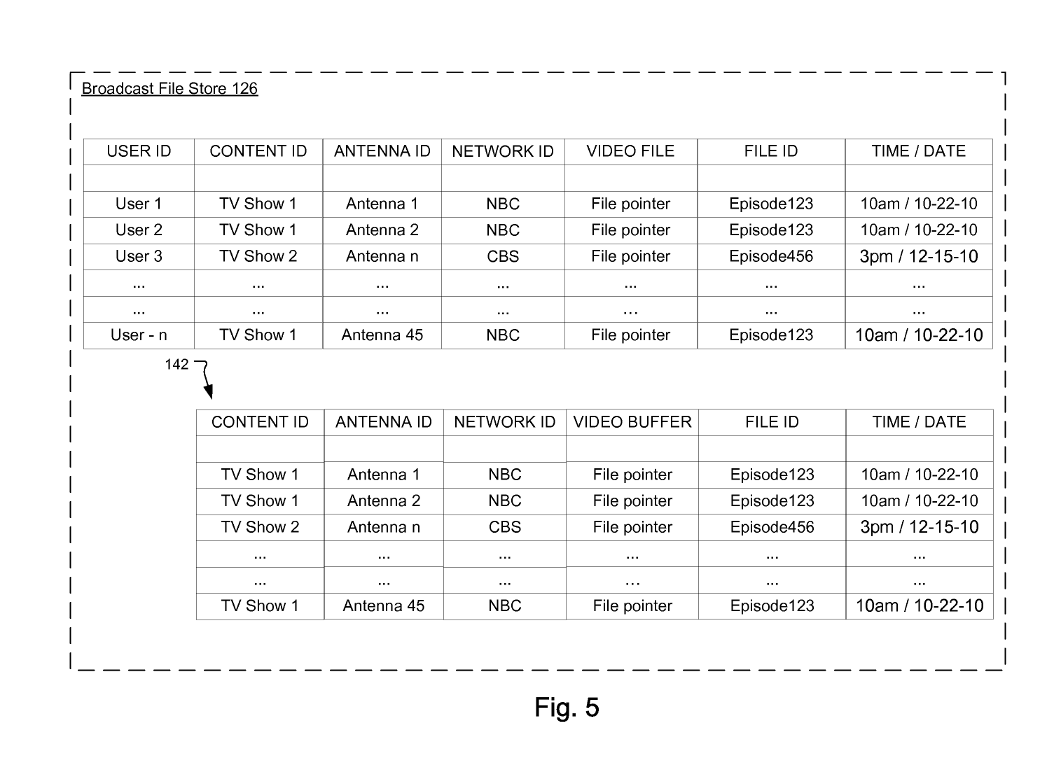

FIG. 5 illustrates the database architecture for storing content data from content transmissions in the broadcast file store 126.

In the illustrated example, each record includes information that identifies the user and the transcoded content data. For example, a user identification field (USER ID) uniquely identifies each user and/or their individual user account. Additionally, every captured content transmission is associated with the user that requested it. The content identification field (CONTENT ID) identifies the title (or name) of the content transmission. Generally, the content name is the title of the television program, television show or movie, that is being recorded or streamed live. An antenna identification field (ANTENNA ID) identifies the specific antenna element that was assigned and then used to capture the content transmission. A network identification field (NETWORK ID) specifies the broadcasting entity or network that broadcast the content transmission. The video file field (VIDEO FILE) contains the content data or typically a pointer to the location of this data. The pointer specifies the storage location(s) of the high, medium, and low quality content data. A file identification field (FILE ID) further indentifies the unique episode, movie, or news broadcast. Lastly, a time and date identification field (TIME/DATE) stores the time and date when the content transmission was captured. In alternative embodiments, records in the broadcast file store 126 could include greater or fewer fields.

By way of an example, User 1 and User 2 both have unique USER ID's and both have their own individual copies of content transmissions even though both users requested the same program at the same time and date, and on the same broadcast network. User 1 is only able to view their copy of content data stored to their USER ID and User 2 is only able to view their copy of the content data stored to their USER ID. Additionally, the unique antenna element that was assigned to each user is also recorded in the ANTENNA ID field.

The file store 126 also includes a temporary buffer 142 that buffers secondary content data that has yet to be assigned to a user. Generally, the temporary buffer 142 operates as a short term buffer that continually overwrites the current secondary content data with newer secondary content data after a predetermined period of time. In one embodiment, the temporary buffer 142 is a First In, First Out (or FIFO) buffer. In an alternative embodiment, the temporary buffer 142 is a ring or circular buffer. The secondary content data are captured and encoded content transmission that the users are most likely to select when requesting new content transmission (e.g. changing channels). Generally, the records in the temporary buffer 142 do not include a USER ID field because the secondary content data in the temporary buffer 142 have not been assigned to any users yet.

Additionally, the streaming server 120 is able to generate reports based on the stored content data and the identification fields. These reports include statistics such as usage by individual, usage by groups, total numbers of users, number of active users, number of scheduled recordings, peak system usage, and total usage of the entire system, to list a few examples.

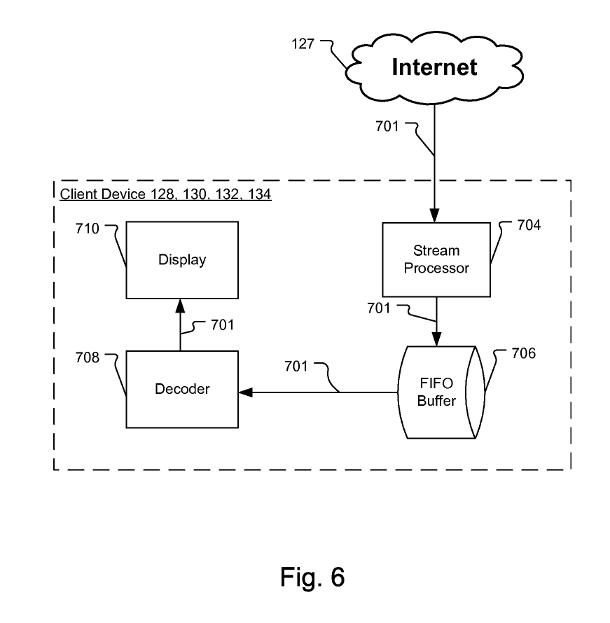

FIG. 6 is a block diagram illustrating the video processing system for content data within a client device.

In a typical implementation, a primary stream of content data 701 is transmitted to the client device via the Internet 127. Typically, the primary stream of content data is content data from the file store 126 associated with the user's account. In alternative embodiments, the stream of content data could be content data streamed from the online file store 144, such as a pay-per-view movie or a movie that is available via subscription service.

The stream processor 704 of the client device processes the stream of content data 701. The stream of content data 701 is then transferred to a client buffer 706. Typically, the client buffer 706 is a FIFO buffer. In alternative embodiments, however, the client buffer 706 is a ring or circular buffer. The content data stream 701 is then passed to the decoder 708. The decoder 706 decodes the buffered content data for viewing and playback. The decoded content data are then sent to the display 710 of the client device to be viewed by the user.

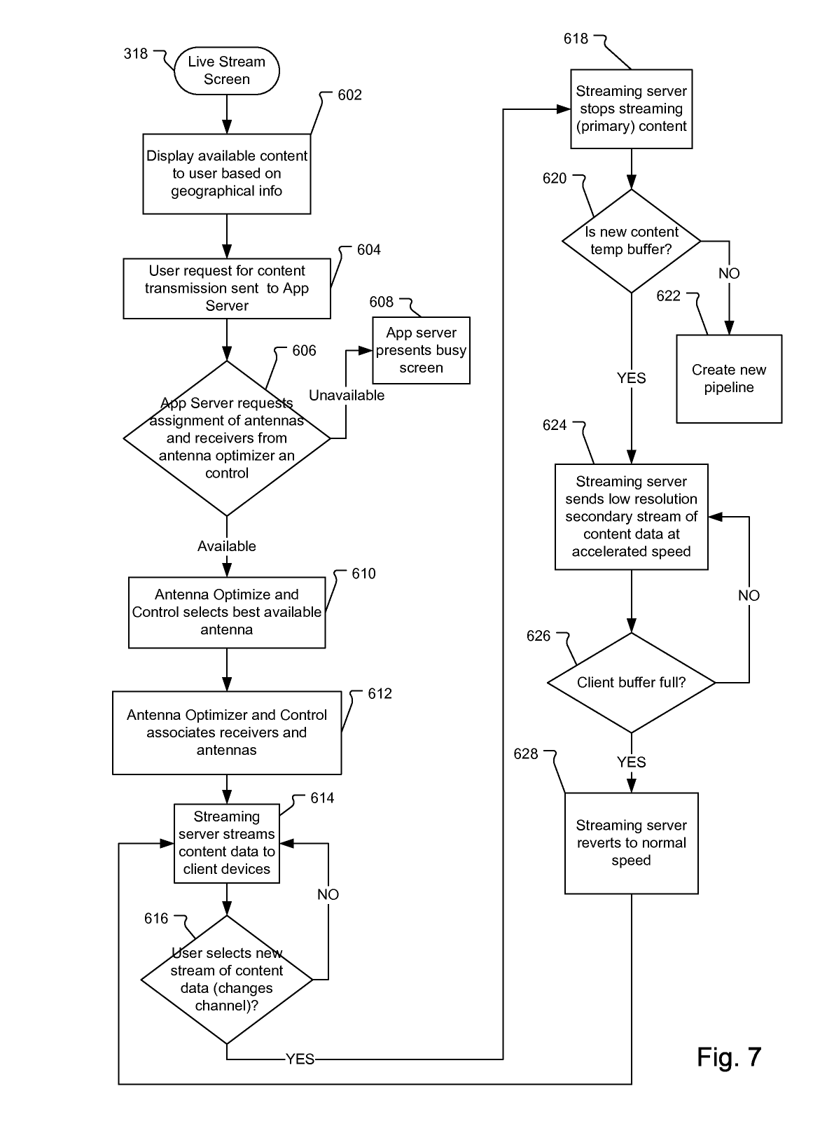

FIG. 7 is a flow diagram illustrating the steps for the system 100 to enable users to watch content transmissions on devices in real time while buffering secondary content on the system 100.

The users begin at the live stream screen 318 that is served to the client devices from the application web server 124. Based on the user's geographical location, a list of available over the air broadcasts is provided in step 602. Additionally, the broadcast time and date are also displayed to the users. The user's request for the over the air broadcast is sent to the application server 124 in step 604. The application server 124 requests assignment of an antennas and receivers from the antenna optimization and control system 116 in step 606.

If the antennas or receivers are not available, then the application server 124 returns a busy screen to the users in step 608. If antennas and receivers are available, then the antenna optimization and control system 116 selects the best available antenna to receive the requested over the air broadcast in step 610. The determination of which antennas to use is based on multiple factors. For example, the location of the broadcasting entity (e.g. a broadcast transmitter), the location of the antenna elements, the orientation of the antennas, and the signal strength are all factors used to determine which antenna element will be used. I

In the next step 612, the antenna optimization and control system 116 associates the receivers and antennas to capture and encode the requested over the air broadcast.

The live stream controller 122 instructs the antenna optimization and control system 116 to configure unused capture and encoding resources to capture additional over the air broadcasts that users are likely to watch in the near future. The live stream controller 122 determines which over the air broadcasts users are likely to watch based on the information collected by the behavior predictor 136. These additional over the air broadcasts are captured by the array of antennas 102 and encoded by the encoder system 103, but are not streamed to any users. Instead, this secondary content data are buffered in the temporary buffer 142 of the file store 126 and continually overwritten (or discarded) by the newer secondary content data that are generated by the system.

In the next step 614 the streaming server 120 streams the primary content data to the client device typically at a resolution selected by the user or dictated by the resolution of the display 710. In alternative embodiments, the resolution of the streamed content data is determined by the size of the display of the media player running on the client devices.

In the next step 616, the streaming server 120 determines if the user has requested to view a new stream of content data (e.g. changed channels to view different over the air broadcast). If the user has not requested to view a new stream of content data, then the streaming server 120 continues to stream the primary content data to the client devices in step 614.

If the user has requested a new (or secondary) stream of content data, then the streaming server 120 stops streaming the primary content data in step 618. In the next step 620, the streaming server 120 determines if the requested stream of content data is in the temporary buffer 142. If the secondary stream of content data is not in the temporary buffer 142, then a new processing pipeline is created in step 622.

If the secondary stream of content data is in the temporary buffer 142, then the streaming server 120 streams the secondary stream of content data to the client device at a low or lower resolution and at an accelerated speed in step 624.The accelerated transfer speed is the maximum transfer speed available using TCP/IP connection. Thus, the transfer speed may be very fast if the underlying link supports high speed transfers. That is, the transfer speed is only limited by the rate available with TCP/IP connection.

In the next step 626, the streaming server determines if the client buffer 706 is full. If the client buffer is not filled, then the streaming server 120 continues to stream the secondary content data at the low resolution and accelerated speed in step 624. If the client buffer 706 is full, then the streaming server 120 reverts to the normal transfer speed and begins to stream higher resolution secondary content data in step 628.

Typically, the higher resolution level was the resolution level originally selected for the primary content data and is typically based on the resolution of the user's display device 710, the display of the media player, or selected by the user. In contrast, the low resolution is a resolution that is lower than selected by the user but nonetheless adequate, at least on a temporary basis, for the display 710.

Now, the secondary stream of content data becomes the (new) primary stream of content data. The streaming server 120 then streams the high resolution (new) primary content data to the client device in step 614.

The advantage of this approach is that when the user requests to view a new stream of content data in a live streaming situation, the system does not need to allocate an antenna and encoding resources and wait for a processing pipeline of the encoder system 103 to fill. Instead, the content data resident in the temporary file store 142 are now streamed to this user.

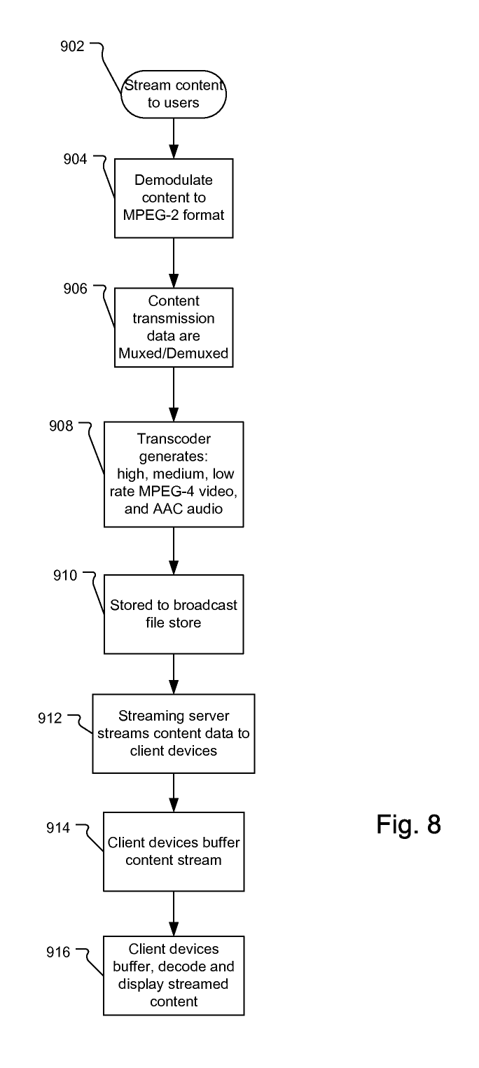

FIG. 8 is a flow chart illustrating the steps for encoding and streaming content data to users in step 614 of FIG. 7.

In the first step 904, the demodulators 106-1 to 106-n decode and demodulate the captured content transmission to content transmission data. In the next step 906, the content transmission data are multiplexed by the multiplexer 108, transmitted across the antenna transport interconnect, and then demultiplexed by the demultiplexer switch 110. The transcoders 112-1 to 112-n then transcode the content transmission data to generate high, medium, and low rate MPEG-4 video and advanced audio coding audio in step 908. In the next step 910, the transcoded content transmission data are stored to the file store 126 as content data.

In the next step 912, the streaming server 120 streams the content data from the file store 126 to the client devices 128, 130, 132, 134. The client devices 128, 130, 132, 134 then buffer, decode and display the streamed content data in step 916.

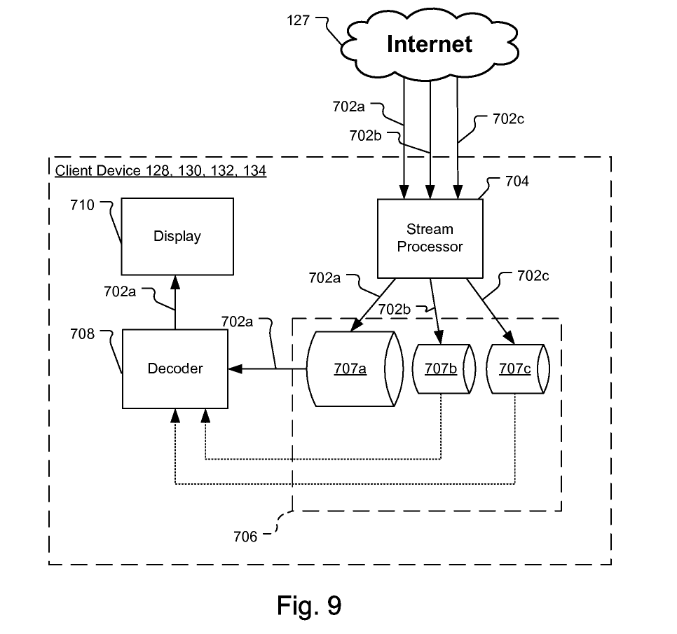

FIG. 9 is a block diagram illustrating the client device receiving and buffering multiple streams of content data according to another buffering technique.

In the illustrated example, multiple streams of content data 702a, 702b, 702c are streamed to the client device via the Internet 127.The stream processor 704 processes and separates the multiple streams of content data 702a, 702b, 702c into a primary content stream 702a, which is content the user is viewing, and one or more secondary content streams 702b, 702c, which is content the user is likely to request when selecting a new content transmission to view. The streams of content data 702a, 702b, 702c are transferred into separates buffers 707a, 707b, 707c within the client buffer 706.

The primary stream of content data 702a is transferred from the buffer 707a to the decoder 708 to be decoded. In contrast, the secondary content streams 702b, 702c are continually overwritten in the separates buffers 707b, 707c by newer content data after a predetermined period of time. Alternatively, the secondary streams of content data could also be replaced by different secondary streams of content data. The decoded primary stream of content data 702a is then sent to the display 710 of the client device to be viewed by the user.

If the user selects one of the secondary streams of content data then, the client buffer stops sending the primary stream of content data to the decoder 708 and begins sending the selected secondary stream of content data to the decoder 708. Here, the secondary stream of content data becomes the (new) primary stream of content data.

In an alternative embodiment, the primary stream of content data could be streamed from the online file store 144. In this scenario, secondary content data from the online file store 144 are typically not streamed to the client device because the secondary content data in the online file store 144 are not from live streaming sources. Thus, when a user requests content from the online file store 144 the system generally handles the request similar to requests for previously recorded content transmissions stored in the file store 126.

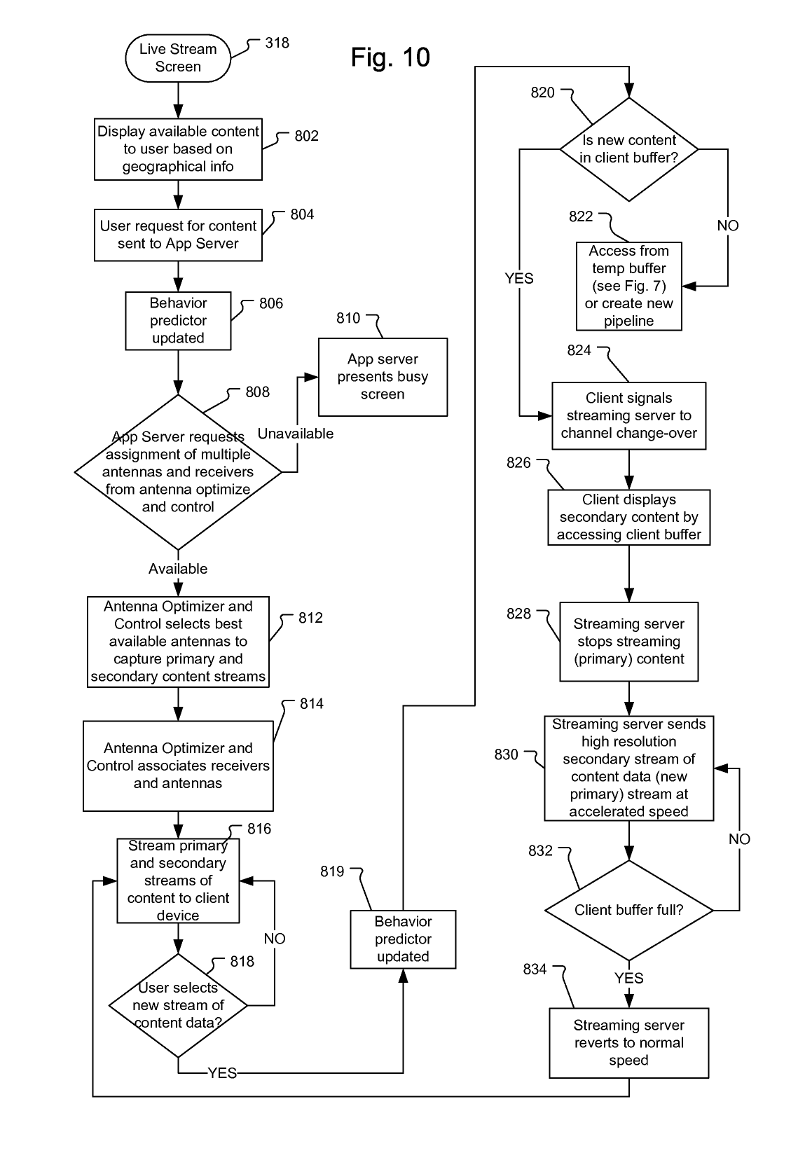

FIG. 10 is a flow diagram illustrating the steps for the system to enable users to watch streams of content data on devices in real time while buffering secondary streams of content data on the client device.

The users begin at the live stream screen 318 that is served to the user devices from the application web server 124. Based on the user's geographical location, a list of available over the air broadcasts is provided in step 802. Additionally, the broadcast time and date are also displayed to the users. The user's request for the over the air broadcasts are sent to the application server 124 in step 804. In the next step 806, the behavior predictor 806 is updated. The application server 124 requests assignment of multiple antennas and receivers from the antenna optimization and control system 116 in step 808.

If the antennas or receivers are not available, then the application server 124 returns a busy screen to the users in step 810. If antennas and receivers are available, then the antenna optimization and control system 116 selects the best available antenna to receive the requested over the air broadcast in step 812. In the next step 814, the antenna optimization and control system 116 associates the receivers and antennas to capture and encode the requested over the air broadcast.

Additionally, the live stream controller 122 instructs the antenna optimization and control system 116 to allocate antennas that are currently not in use to capture additional over the air broadcasts that the user is likely to watch in the near future. The live stream controller 122 determines which additional over the air broadcasts to capture based on information collected by the behavior predictor 136. These additional over the air broadcasts are captured and encoded as secondary content data by the system.

In the next step 816 the streaming server 120 streams the primary and secondary streams of content data to the client device. In the next step 818, the streaming server 120 determines if the user has requested to view a new stream of content data (e.g. changed channels). If the user has not requested a stream of content data, then the streaming server 120 continues to stream the primary and secondary streams of content data to the client devices in step 816.

If the user requests a new stream of content data, then the behavior predictor 136 is updated in step 819. In the next step 820, the streaming server 120 determines if the new stream of content data is one of the secondary streams of content data in the client buffer 706. If the stream of content data is not buffered in the client buffer 706, then the streaming server 120 determines if the stream of content data is buffered in the temporary buffer 142 of the file store 126 (see FIG. 7) or creates a new processing pipeline in step 822.

If the requested stream of content data is in the client buffer 706, then client device signals the streaming server about the channel change over in step 824. In the next step 826, the client device decodes and displays the stream of content data by accessing the secondary stream of content data in the client buffer. In the next step 828, the streaming server 120 stops streaming the primary stream of content data.

In the next step 830, the streaming server 120 streams higher resolution secondary content data (which becomes the new primary stream of content data) at an accelerated transfer speed. The accelerated transfer speed is only limited by the transfer speed available over the TCP/IP connection. In the next step 832, the streaming server 120 determines if the client buffer 706 is full. If the client buffer is not full, then the streaming server 120 continues to stream the high resolution secondary content data in step 830 at the fastest rate possible over the connection.

If the client buffer is full, then the streaming server 120 reverts to the normal transfer speed to keep to client buffer filled with the high resolution content in step 834. The streaming server 120 then continues to stream the high resolution content data to client device in step 816.

The advantage of this approach is that when the user requests to view a new stream of content data, the content data has already been streamed to the client device. Thus, there is minimal delay in switching to the new stream of content data. The content data which were previously discarded are now decoded and displayed on the client device with minimal delay.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for processing content transmissions, the method comprising:
receiving user requests for content transmissions including requests to receive the content transmissions in real time and requests to record the content transmissions;
for the requests to receive the content transmissions in real time, transcoding the content transmissions to content data and streaming the content data to the users; and
for the requests to record the content transmissions, storing at least some of the content transmissions as content transmission data in a temporary file store and then later transcoding the content transmission data to the content data for streaming to the users.

2. The method according to claim 1, wherein the content transmission data are transcoded into high, medium, and low-rate MPEG-4 video format and advanced audio coding audio format content data.

3. The method according to claim 1, wherein the content transmission data are stored in the temporary file store in MPEG-2 format.

4. The method according to claim 1, further comprising performing the later transcoding of the content transmission data to the content data during periods of lower electricity costs.

5. The method according to claim 1, further comprising streaming the content data via the Internet.

6. The method according to claim 1, further comprising prioritizing the user requests to receive the content transmissions in real time before the user requests to record the content transmissions in terms of transcoder resources.

7. The method according to claim 1, further comprising storing the content transmission data in the temporary file store if transcoder usage exceeds a threshold.

8. The method according to claim 7, further comprising transcoding the content transmission data in the temporary file store to the content data and storing the content data in a file store if the transcoder usage falls below a threshold.

9. The method according to claim 1, wherein the content transmissions are over the air broadcasts captured by antenna elements.

10. A content transmission processing system, the system comprising:
an application server that receives requests for content transmissions from users, wherein the requests include requests to receive the content transmissions in real time and requests to record the content transmissions for later display;
transcoders for transcoding content transmission data of the content transmissions to content data;
a temporary file store for the storing content transmission data;
a controller that assigns transcoders to transcode the content transmissions data for the requests to receive the content transmissions in real time and directs at least some of the content transmission data to be stored in the temporary file store for the requests to record the content transmissions for later display; and
a streaming server that streams the content data to users.

11. The system according to claim 10, further comprising a file store that stores the content data from the transcoders.

12. The system according to claim 10, wherein the content transmission data are stored in the temporary file store in MPEG-2 format.

13. The system according to claim 10, wherein the streaming server streams the content data via to the users via the Internet.

14. The system according to claim 10, wherein the transcoders transcode the content transmission data into high, medium, and low-rate MPEG-4 video format content data.

15. The system according to claim 10, wherein the content transmission data are stored in the temporary file store in MPEG-2 format.

16. The system according to claim 10, wherein the controller prioritizes the usage of transcoders to enable the user requests to receive the content transmissions in real time to be processed before the user requests to record the content transmissions.

17. The system according to claim 16, wherein the controller instructs the transcoders to transcode the content transmission data in the temporary file store if the usage of the transcoders falls below a threshold.

18. The system according to claim 11, wherein the content transmissions are over the air broadcasts captured by antenna elements.

19. The system according to claim 11, wherein the controller instructs the transcoders to transcode the content transmission data in the temporary file store to the content data during periods of lower electricity costs.

20. The system according to claim 11, further comprising antenna elements for capturing the content transmissions and demodulators for generating the content transmission data from the content transmissions captured by the antenna elements.

21. A method for processing content transmissions, the method comprising:
an encoding system receiving the content transmissions;
determining usage of transcoders in the encoding system;
the encoding system storing at least some of the received content transmissions as content transmission data in a temporary file store if the usage of the transcoders exceeds a threshold; and
the encoding system later transcoding the content transmission data stored in the temporary file store to content data.

22. The method according to claim 21, further comprising storing the content data in a file store.

23. A content transmission processing system, the system comprising:
an application server receiving requests for content transmissions from users; and
an controller determining usage of transcoders that transcode content transmission data of the content transmissions to content data for streaming to users and storing at least some of the received content transmissions in a temporary file store as the content transmission data if the usage of the transcoders exceeds a threshold.

24. The system according to claim 23, further comprising a streaming server that streams the content data to client devices.

25. A method for streaming recorded content transmissions, the method comprising:
receiving user requests for recorded content transmissions;
determining if the recorded content transmissions are stored in a temporary file store as content transmission data or in a file store as content data;
for the content data stored in the file store, streaming the content data to client devices; and
for the content transmissions stored in the temporary file store, transcoding the content transmission data to the content data and streaming the content data to client devices.

26. The method according to claim 25, further comprising storing the content data from the content transmission data stored in the temporary file store in the file store.

27. The method according to claim 25, further comprising storing the content transmission data in the temporary file store in MPEG-2 format and transcoding the content transmission data to MPEG-4 format.

28. The method according to claim 25, further comprising streaming the content data to the client devices via the Internet.

29. The method according to claim 25, further comprising continuing to transcode the content transmission data to the content data after users request to discontinue streaming the recorded content transmissions.

30. The method according to claim 25, further comprising transcoding the content transmission data into high, medium, and low-rate MPEG-4 video format content data.

31. The method according to claim 25, further comprising storing the content transmission data in the temporary file store in MPEG-2 format.

32. The method according to claim 31, further comprising generating the content transmission data by capturing and decoding over the air broadcasts captured with antenna elements.

33. A system for streaming recorded content transmissions to client devices, the system comprising:
an application server receiving user requests for recorded content transmissions;
a stream controller that determines if the user requested content transmissions are stored in a temporary file store as content transmission data or are stored in a file store as content data;
a controller that instructs transcoders to transcode the user requested content transmissions to the content data if the user requested content transmissions are stored in the temporary file store; and
a streaming server that streams the content data to the client devices.

34. The system according to claim 33, wherein the transcoders transcode the content transmission data into high, medium, and low-rate MPEG-4 video format.

35. The system according to claim 33, wherein the content transmission data are stored in the temporary file store in MPEG-2 format.

36. The system according to claim 33, wherein the streaming server streams the content data to the client devices through the Internet.

37. The system according to claim 33, wherein the streaming server streams the content data stored in a file store to the client devices.

38. The system according to claim 33, wherein the transcoders continue to transcode the content transmission data after users request to discontinue streaming the content data.

39. The system according to claim 33, wherein the content transmission data are generated from captured and demodulated over the air broadcasts.

40. A method for switching to new content data streams, the method comprising:
encoding first content transmissions as first content data;
streaming the first content data to client devices for display;
encoding second content transmissions as second content data and buffering the second content data; and
upon user selection of the second content data, displaying the second content data on the client devices.

41. The method according to claim 40, further comprising streaming the second content data to the client devices.

42. The method according to claim 40, further comprising buffering the second content data in storage mediums of the client devices.

43. The method according to claim 40, further comprising buffering the second content data in a file store of an encoding system.

44. The method according to claim 43, further comprising streaming the second content data from the file store to the client devices at an accelerated streaming rate in response to the user selection of the second content data.

45. The method according to claim 40, further comprising buffering the second content data for a predefined length of time before overwriting the second content data.

46. A system for streaming content transmissions to client devices, the system comprising:
an encoding system that encodes first content transmissions as first content data and encodes second content transmissions as second content data;
a buffer for storing the second content data; and
a streaming server that streams the first content data to client devices for display.

47. The system according to claim 46, wherein the streaming server streams the second content data to the client devices and buffer is located on the client devices.

48. The system according to claim 46, wherein the buffer is located in a file store of the encoding system.

49. The system according to claim 48, wherein the second content data are transferred from the file store of the encoding system to the client devices at an accelerated transfer rate in response to user selection of the second content data.

50. The system according to claim 49, wherein the accelerated transfer speed is a maximum transfer speed available over a TCP/IP connection.

51. The system according to in claim 46, wherein the second content data is stored in the buffer for a predefined length of time before being overwritten.

52. A method for streaming content data at multiple resolutions, the method comprising:
streaming the content data to client devices at a selected resolution;
upon detecting user selection of second content data, streaming the second content data to the client devices at a lower resolution and then streaming the second content data at the selected resolution.

53. The method according to claim 52, further comprising selecting the selected resolution based on a display resolution of the client devices.

54. The method according to claim 52, further comprising determining the selected resolution based on available communication channels.

55. The method according to claim 54, wherein the available communication channels are third generation cellular wireless networks, fourth generation cellular wireless networks, or local area networks.

56. A system for streaming content data to client devices, the system comprising:
a streaming server that streams first streams of the content data to the client devices at a selected resolution;
an application server that receives user requests for second streams of the content data;
wherein the application server instructs the streaming server to stream the second streams of the content data to the client devices at a lower resolution and then later stream the second streams of the content data at the selected resolution.

57. The system according to claim 56, wherein the selected resolution is based on display resolutions of the client devices.

58. The system according to claim 56, wherein the selected resolution is based on available communication channels.

59. The system according to claim 58, wherein the available communication channels are third generation wireless networks, fourth generation wireless networks, or local area networks.
